(19) United States
(12) Patent Application Publication
(10) Pub. No.: US 2006/0222906 A1
(43) Pub. Date: Oct. 5, 2006

(54) Radiation curing polyurethane resin for magnetic recording medium, method of manufacturing radiation curing polyurethane resin for magnetic recording medium, and magnetic recording medium

(75) Inventors: Hiroyuki Tanaka, Tokyo (JP); Tsutomu Ide, Tokyo (JP); Katsuhiko Yamazaki, Tokyo (JP)

Correspondence Address: GREENBLUM & BERNSTEIN, P.L.C., 1950 ROLAND CLARKE PLACE, RESTON, VA, 20191, US

(73) Assignee: TDK Corporation, Tokyo (JP)

(21) Appl. No.: 11/392,786

(22) Filed: Mar. 30, 2006

(30) Foreign Application Priority Data
Mar. 31, 2005 (JP) 2005-102067

(51) Int. Cl. G11B 5/716

(52) U.S. Cl. 428/840.5; 428/423.1; 528/44

(57) ABSTRACT

A radiation curing polyurethane resin for a magnetic recording medium which is capable of realizing a lower non-magnetic layer that can secure sufficient coating film strength with a lower radiation dose. A polyurethane resin which contains active hydrogen, and a sulfur-containing polar group in an amount of not less than 0.05 mmol/g to not more than 0.10 mmol/g, inclusive, but does not contain a basic polar group in its molecule and is formed only by an aliphatic segment, is modified on the active hydrogen into a radiation curing polyurethane resin by a compound having an acrylic double bond.

### BACKGROUND OF THE INVENTION

1. Field of the Invention

The present invention relates to a radiation curing polyurethane resin for a magnetic recording medium, a method of manufacturing the radiation curing polyurethane resin, and a magnetic recording medium manufactured using the radiation curing polyurethane resin.

2. Description of the Related Art

As a radiation curing polyurethane resin for a magnetic recording medium, of the above-mentioned kind, there is known a radiation curing polyurethane resin disclosed in Japanese Laid-Open Patent Publication (Kokai) No. 2004-123815. This radiation curing polyurethane resin is formed by modifying a polyurethane resin containing active hydrogen, and a basic polar group and a sulfur-containing polar group in its molecule on the active hydrogen by a compound having two or more acrylic double bonds into a radiation curing type, and has a high crosslinking property. Therefore, by using the radiation curing polyurethane resin, it is possible to form a lower non-magnetic layer of a magnetic recording medium with excellent dispersibility and surface properties, and sufficient coating film strength.

### SUMMARY OF THE INVENTION

By the way, the present inventors have made further studies on the radiation curing polyurethane resin disclosed in the above-mentioned publication, and have found out that even radiation curing polyurethane resins disclosed as Comparative Examples in the publication can be further improved to thereby realize a lower non-magnetic layer which can secure sufficient coating film strength with a lower radiation dose.

It is a main object of the present invention to provide a radiation curing polyurethane resin for a magnetic recording medium, which is capable of realizing a lower non-magnetic layer that can secure sufficient coating film strength with a lower radiation dose. Further, it is another main object to provide a method of manufacturing the resin, and a magnetic recording medium manufactured using the resin.

To attain the above main object, according to a first aspect of the present invention, there is provided a radiation curing polyurethane resin for a magnetic recording medium, produced by modifying a polyurethane resin which contains active hydrogen, and a sulfur-containing polar group in an amount of not less than 0.05 mmol/g to not more than 0.10 mmol/g, inclusive, but does not contain a basic polar group in its molecule and is formed only by an aliphatic segment, the polyurethane resin being modified on the active hydrogen into a radiation curing type by a compound having an acrylic double bond.

According to this radiation curing polyurethane resin for a magnetic recording medium, a polyurethane resin which contains active hydrogen, and a sulfur-containing polar group in an amount of not less than 0.05 mmol/g to not more than 0.10 mmol/g, inclusive, but does not contain a basic polar group in its molecule and is formed only by an aliphatic segment, is modified on the active hydrogen into a radiation curing type by a compound having an acrylic double bond, whereby the radiation curing polyurethane resin is manufactured. Therefore, by using the radiation curing polyurethane resin, it is possible to manufacture magnetic recording media which have sufficiently high surface hardness (coating film strength), with a sufficiently low center line average roughness, and yet are sufficiently low in bit error rate even with a low radiation dose. Further, the magnetic recording media can be manufactured with a low radiation dose, which makes it possible to sufficiently enhance productivity.

To attain the above other main object, according to a second aspect of the present invention, there is provided a method of manufacturing the radiation curing polyurethane resin for a magnetic recording medium described above, wherein a polyurethane resin which contains active hydrogen, and a sulfur-containing polar group in an amount of not less than 0.05 mmol/g to not more than 0.10 mmol/g, inclusive, but does not contain a basic polar group in its molecule and is formed only by an aliphatic segment, is used as a raw material, and the active hydrogen is caused to react with a compound having an acrylic double bond in its molecule, whereby the polyurethane resin is modified into a radiation curing type.

According to this method of manufacturing the radiation curing polyurethane resin for a magnetic recording medium, a polyurethane resin which contains active hydrogen, and a sulfur-containing polar group in an amount of not less than 0.05 mmol/g to not more than 0.10 mmol/g, inclusive, but does not contain a basic polar group in its molecule and is formed only by an aliphatic segment, is modified on the active hydrogen into a radiation curing type by a compound having an acrylic double bond, whereby the radiation curing polyurethane resin is manufactured. Therefore, it is possible to manufacture a radiation curing polyurethane resin which makes it possible to manufacture magnetic recording media that have a sufficiently high surface hardness (coating film strength), with a sufficiently low center line average roughness, and yet are sufficiently low in bit error rate even with a low radiation dose.

Preferably, as the compound, there is used a compound obtained by causing an isocyanate to react with an alcohol which contains at least one acrylic double bond in its molecule. This makes it possible to reliably manufacture the radiation curing polyurethane resin.

Further, to attain the above other main object, according to a third aspect of the present invention, there is provided a magnetic recording medium comprising a lower non-magnetic layer and a magnetic layer formed in the mentioned order on one surface of a non-magnetic substrate, wherein the lower non-magnetic layer contains the above-described radiation curing polyurethane resin for a magnetic recording medium.

According to this magnetic recording medium, a lower non-magnetic layer and a magnetic layer are formed on one surface of a non-magnetic substrate in the mentioned order, and the lower non-magnetic layer contains the above-described radiation curing polyurethane resin for a magnetic recording medium. Therefore, it is possible to realize a magnetic recording medium which is sufficiently high in the strength (coating film strength) of the lower non-magnetic layer by curing the radiation curing polyurethane resin with a low radiation dose. Further, since the radiation curing polyurethane resin can be cured with a low radiation dose, the productivity can be sufficiently enhanced. As a result, it is possible to realize inexpensive magnetic recording media.

It should be noted that the present disclosure relates to the subject matter included in Japanese Patent Application No. 2005-102067 filed Mar. 31, 2005, and it is apparent that all the disclosures therein are incorporated herein by reference.

### BRIEF DESCRIPTION OF THE DRAWINGS

These and other objects and features of the present invention will be explained in more detail below with reference to the attached drawings, wherein:

FIG. 1 is a cross-sectional view of a magnetic tape as an example of a magnetic recording medium according to the present invention;

FIG. 2 is a view showing a relationship between electron beam-curing polyurethane resins and gel fractions thereof obtained by measurement;

FIG. 3 is a view showing a relationship between Examples and Comparative Examples, and values of center line surface roughness thereof obtained by measurement;

FIG. 4 is a view showing a relationship between Examples and Comparative Examples, and values of surface hardness thereof obtained by measurement;

FIG. 5 is a view showing a relationship between Examples and Comparative Examples, and bit error rates thereof obtained by measurement.

### DESCRIPTION OF THE PREFERRED EMBODIMENTS

Now, the best mode of the radiation curing polyurethane resin for a magnetic recording medium, the method of manufacturing the resin, and the magnetic recording medium manufactured using the resin according to the present invention will be described with reference to the accompanying drawings.

First, a description will be given of the radiation curing polyurethane resin for a magnetic recording medium according to the present invention. This radiation curing polyurethane resin is obtained by using a predetermined polyurethane resin as a raw material, and subjecting the resin to radiation-sensitive modification using a predetermined compound (hereinafter referred to as “modifying compound”).

As the polyurethane resin as a raw material, to cause the reaction with the modifying compound described later, there is employed a polyurethane resin which contains active hydrogen such as a hydroxyl group, and a sulfur-containing polar group but does not contain a basic polar group in its molecule and is formed only by an aliphatic segment. In the radiation curing polyurethane resin according to the present invention, when the polyurethane resin formed as described above is used as a binder in a lower non-magnetic layer, a high crosslinking property is exhibited, whereby it is possible to realize a lower non-magnetic layer which is excellent in dispersibility and surface properties and has a sufficient coating film strength with a radiation dose (electron beam dose) lower than usual.

As the sulfur-containing polar group, —SO₄Y and —SO₃Y (Y is a hydrogen atom or alkaline metal) are preferable. It is considered that by using these sulfur-containing polar groups, the radiation curing polyurethane resin properly acts on non-magnetic powder, particularly, non-magnetic iron oxides, to thereby further improve the dispersibility in the lower non-magnetic layer. Further, it is preferable that each molecule contains not less than 0.05 mmol/g to not more than 0.10 mmol/g, inclusive, of the sulfur-containing polar group. If the content of the sulfur-containing polar group is less than 0.05 mmol/g, the viscosity of the polyurethane resin during dispersion thereof becomes too high, which is unpreferable, whereas if the same is more than 0.10 mmol/g, the viscosity of the polyurethane resin as a raw material becomes so high that the radiation curing polyurethane resin cannot be made. It should be noted that the sulfur-containing polar group may be bonded to the main chain of the segment polyurethane resin or a branch chain of the same. Further, introduction of the sulfur-containing polar group into the polyurethane resin can be performed by a known method.

As the modifying compound which is caused to react with active hydrogen in the polyurethane resin to perform radiation-sensitive modification, there is used a compound which has an acrylic double bond in its molecule. The modifying compound can be obtained e.g., by causing one isocyanate group of a diisocyanate to react with a hydroxyl group of an alcohol which contains at least one acrylic double bond in its molecule. By causing the modifying compound thus obtained to react with hydroxyl groups in the polyurethane resin, it is possible to introduce acrylic double bonds into each of hydroxyl groups of the polyurethane resin.

Further, as the modifying compound, it is also possible to use a compound which contains two or more acrylic double bonds and an isocyanate group in its molecule. This modifying compound can be obtained by causing a compound which contains both a hydroxyl group and an acrylic double bond in its molecule to react with two of three isocyanate groups of trimers (isocyanurates) of hexamethylene diisocyanate (HDI), thereby causing the resulting compound to contain both two acrylic double bonds and one isocyanate group. The modifying compound thus obtained is caused to react e.g., with hydroxyl groups in the polyurethane resin, whereby an acrylic double bond can be introduced to each hydroxyl group in the polyurethane resin. As the isocyanurate, besides HDI, there may be used e.g., tolylene diisocyanate (TDI), isophorone diisocyanate (IPDI), and the like, but the isocyanurate that can be used is not limited to these. Further, the compound which contains both a hydroxyl group to be reacted with an isocyanurate and acrylic double bonds, i.e., an alcohol which contains at least one acrylic double bond in its molecule is not particularly limited, but it is preferable to use 2-hydroxyethyl methacrylate (2-HEMA), for example.

The synthesis of radiation curing polyurethane resins is executed specifically by an urethanation reaction among three compounds, i.e., an isocyanate having two or more isocyanate groups, an alcohol containing at least one acrylic double bond in its molecule, and a polyurethane resin containing active hydrogen.

As the synthesis method, it is preferable to employ a method in which an isocyanate and an alcohol containing at least one acrylic double bond in its molecule are caused to react with each other in advance, and after the above-mentioned modifying compound is obtained, the polyurethane resin having active hydrogen is caused to react with the modifying compound.

In the synthesis, normally, it is preferable to add 0.005 parts by weight to 0.1 parts by weight, inclusive, of urethanation catalyst such as dibutyltin dilaurate or tin octylate per 100 parts by weight of a total of the reactants, but a urethanation catalyst may not be used.

The radiation curing polyurethane resin described above can be used in the magnetic recording medium as a binder in a resin undercoat layer, a lower non-magnetic layer including inorganic pigments, a back coat layer, and a magnetic layer. These layers will also be generically referred to hereinafter as “functional layers”. The radiation curing polyurethane resin according to the present invention is particularly suitable for the lower non-magnetic layer when it is used in combination with carbon black therein. The radiation curing polyurethane resin may be used singly or in combination, as an admixture thereof with another resin, a typical example of which is a vinyl chloride resin.

The radiation used in the present invention may be any of an electron beam, γ rays, β rays, ultraviolet rays, etc., and preferably, it is an electron beam. The dose is preferably 1 Mrad to 10 Mrad, more preferably 2 Mrad to 7 Mrad, inclusive. Further, it is preferable that the irradiation energy (acceleration voltage) is not lower than 100 kV. The radiation is preferably irradiated before winding after coating and drying, but it may be irradiated after winding.

Next, a description will be given of the construction of a magnetic tape as an example of the magnetic recording medium including a functional layer (e.g., a lower non-magnetic layer) formed by using the radiation curing polyurethane resin described above, with reference to the drawings.

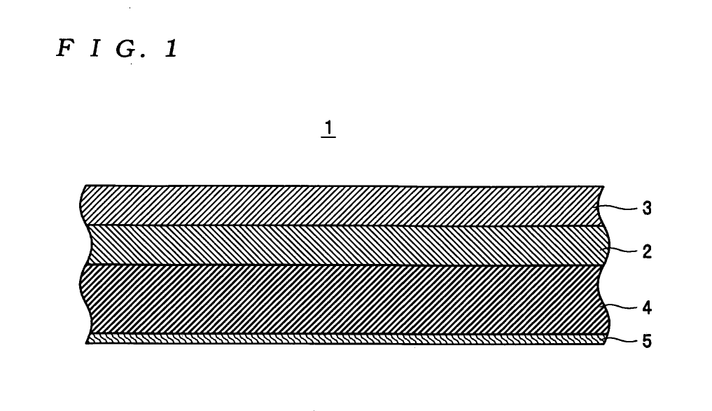

The magnetic tape 1 shown in FIG. 1 has a lower non-magnetic layer 2 and a magnetic layer 3 formed on one side (upper side as viewed in FIG. 1) of a base film (non-magnetic substrate in the present invention) 4 in the mentioned order so that the magnetic tape 1 can be used by a recording/reproducing apparatus, not shown, for recording and reproducing various record data. Further, the magnetic tape 1 has a back coat layer 5 formed on the other side (lower side as viewed in FIG. 1) of the base film 4 so as to improve tape-running performance as well as to prevent the base film 4 from being damaged by scratching (or wear) and the magnetic tape 1 from being electrically charged. It should be noted that in FIG. 1, for purposes of ease of understanding of the present invention, the thickness of the magnetic tape 1 is exaggerated, and the thickness ratio of the layers is illustrated differently from the actual thickness ratio. In this case, to improve the adhesion of the lower non-magnetic layer 2 to the base film 4, an undercoat layer (easy adhesive layer) may be provided between the base film 4 and the lower non-magnetic layer 2.

The base film 4 can be properly selected from known resin films of various flexible materials, e.g., polyester resins such as polyethylene terephthalate and polyethylene naphthalate, polyamide resins, aromatic polyamide resins, and laminated resin films of these, and the thickness of the base film 4 is also within a known range, but not in a particularly limited range.

The lower non-magnetic layer 2 is provided for improving electromagnetic conversion characteristics of the magnetic layer 3 formed as a thin film, to thereby further increase the reliability of the magnetic tape 1. Further, it is preferable that the lower non-magnetic layer 2 contains carbon black. Carbon black plays the role of reducing surface electrical resistance of the magnetic layer 3 and holding lubricant added to the coating, as well as the role of being a source of supply of lubricant to the magnetic layer 3 and improving the surface properties of the magnetic layer 3 by filling the projections of the base film 4.

Further, in the lower non-magnetic layer 2, besides carbon black, it is possible to use other non-magnetic powders in combination therewith. Examples of the non-magnetic powders other than carbon black include needle-shaped non-magnetic iron oxides (α-Fe₂O₃), calcium carbonate (CaCO₃), α-alumina (α-Al₂O₃), barium sulfate (BaSO₄), titanium oxide (TiO₂), Cr₂O₃, SiO₂, ZnO, ZrO₂, SnO₂, and so forth, but are not limited to these. Among them, if α-Fe₂O₃ in the form of needles having an average major axis diameter of not more than 200 nm or α-Fe₂O₃ in the form of spheres having an average diameter of 20 nm to 100 nm, inclusive, is used, it is possible to soften thixotropy of a coating material composed only of carbon black, and harden the coating film. Further, when α-Al₂O₃ or Cr₂O₃ having an average particle diameter of 0.1 μm to 1.0 μm, inclusive, is used as an abrasive in combination, this contributes to an increase in the strength of the lower non-magnetic layer. Of these pigments, the content of carbon black is 5 wt % to 100 wt %, preferably 10 wt % to 100 wt %, inclusive. If the content of carbon black is less than 5 wt %, the capability to hold added lubricant lowers and the durability of the magnetic tape is degraded. Further, this increases surface electric resistance of the magnetic layer and light transmittance. The carbon black to be used is not particularly limited, but it is preferable to use a carbon black having an average particle diameter of 10 nm to 80 nm, inclusive. Such a carbon black can be selected from furnace carbon black, thermal carbon black, acetylene black, and so forth, and may be of a single system or a mixed system. Further, the BET specific surface area of these carbon blacks is preferably 50 m²/g to 500 m²/g, more preferably 60 m²/g to 250 m²/g, inclusive. For the carbon blacks that can be used in the present invention, “Carbon Black Handbook” (compiled by Carbon Black Association) may be consulted.

Further, it is preferable to cause the lower non-magnetic layer 2 to contain a lubricant in addition to the materials mentioned above. As the lubricant, it is possible to use known substances, such as higher fatty acids, higher fatty esters, paraffin, and fatty acid amides.

Further, as the binder resin for the lower non-magnetic layer 2, it is possible not only to use the radiation curing polyurethane resin alone according to the present invention, but also to use the same in combination with any of other conventionally known thermoplastic resins, thermosetting resins, and other radiation curing resins. Examples of such resins include (meth)acrylic resins, polyester resins, vinyl chloride-based copolymers, acrylonitrile-butadiene-based copolymers, polyamide resins, polyvinyl butyral, nitrocellulose, styrene-butadiene-based copolymers, polyvinyl-alcohol resins, acetal resins, epoxy-based resins, phenoxy-based resins, polyether resins, polyfunctional polyethers, such as polycaprolactone, polyamide resins, polyimide resins, phenol resins, and resins obtained by modifying polybutadiene elastomer and the like to a radiation curing type. Of these, vinyl chloride-based copolymers are preferable.

Further, to the lower non-magnetic layer 2, it is possible to further add a dispersant, such as a surfactant, and other various additives, as desired. Further, the coating material for the lower non-magnetic layer 2 can be prepared using approximately the same amount of the same organic solvents as used for the magnetic layer 3. The thickness of the lower non-magnetic layer 2 is preferably not more than 2.5 μm, preferably 0.1 μm to 2.3 μm, inclusive. Even if the thickness is made larger than 2.5 μm, a further improvement of the performance cannot be expected, but instead, non-uniformity in thickness tends to be caused and coating conditions thereof become more strict, with increased possibilities of degradation of surface smoothness when providing a coating film.

As the ferromagnetic powder used in the magnetic layer 3, it is preferable that a metal alloy fine powder or a hexagonal plate fine powder is used. The metal alloy fine powder preferably has a coercive force Hc of 119.4 kA/m to 238.7 kA/m (1500 Oe to 3000 Oe), a saturation magnetization σs of 110 Am²/kg to 160 Am²/kg (110 emu/g to 160 emu/g), an average major axis diameter of 0.03 μm to 0.15 μm, an average minor axis diameter of 10 nm to 20 nm, and an aspect ratio of 1.2 to 20, inclusive. Further, it is preferable that the coercive force Hc of the prepared magnetic recording medium is 119.4 kA/m to 238.7 kA/m (1500 Oe to 3000 Oe), inclusive. As additive elements, there may be added Ni, Zn, Co, Al, Si, Y, and other elements including rare earth elements, depending on the purpose. The hexagonal plate fine powder preferably has a coercive force Hc of 79.6 kA/m to 302.4 kA/m (1000 Oe to 3800 Oe), a saturation magnetization σs of 50 Am²/kg to 70 Am²/kg (50 emu/g to 70 emu/g), an average plate particle diameter of 20 nm to 80 nm, and a plate ratio of 2 to 7, inclusive. Further, it is preferable that the coercive force Hc of the magnetic tape 1 formed using the hexagonal crystal plate fine powder is within a range of 95.5 kA/m to 318.3 kA/m (1200 Oe to 4000 Oe), inclusive. As additive elements, there may be added Ni, Co, Ti, Zn, Sn, and other elements including rare earth elements, depending on the purpose. As the other materials, it is possible to use known materials without particular limits, depending on the purpose. It is only required that such a ferromagnetic powder is contained in the composition of the magnetic layer 3, in an amount of around 70 wt % to 90 wt %, inclusive. If the content of the ferromagnetic powder is too large, the content of the binder decreases, which tends to degrade the surface smoothness by calendering, whereas if the same is too small, it is difficult to obtain a high reproduction output.

As the binder resin for the magnetic layer 3, besides the above-described radiation curing polyurethane resin according to the present invention, it is possible to suitably use conventionally known thermoplastic resins, thermosetting resins, and other radiation curing resins, and mixtures of these, but the binder resin is not particularly limited to any of them. Further, it is also possible to use mixtures of the above-described radiation curing polyurethane resin and other binder resins. In this case, the content of these binder resins is preferably 5 parts by weight to 40 parts by weight, more preferably 10 parts by weight to 30 parts by weight, inclusive, per 100 parts by weight of the ferromagnetic powder. If the binder resin content is too small, the strength of the magnetic layer 3 becomes low, and the running durability is likely to be degraded. On the other hand, if the binder resin content is too large, the ferromagnetic metal powder content becomes low, which degrades electromagnetic conversion characteristics of the magnetic layer 3.

As the crosslinking agent (hardener or curing agent) for curing these binder resins, there may be mentioned e.g., known various polyisocyanates in the case of thermosetting resins, and the content of the crosslinking agent is preferably 10 parts by weight to 30 parts by weight, inclusive, per 100 parts by weight of the binder resin. Further, abrasives, dispersants such as surfactants, higher fatty acids, and various other additives may be added to the magnetic layer 3.

The coating material for forming the magnetic layer 3 is prepared by adding organic solvents to the above mentioned components. The organic solvents that can be used are not particularly limited, but one or more of various kinds of solvents such as ketone solvents including methyl ethyl ketone (MEK), methyl isobutyl ketone, and cyclohexanon, and aromatic solvents such as toluene may be selectively used as required. The amount of the organic solvents to be added may be set to about 100 parts by weight to 900 parts by weight, inclusive, per 100 parts by weight of a total of the solids (ferromagnetic metal powder and various inorganic particles) and binder resins.

The thickness of the magnetic layer 3 is not more than 0.50 μm, and preferably 0.01 μm to 0.50 μm, further preferably 0.02 μm to 0.30 μm, inclusive. If the magnetic layer 3 is too thick, the self-demagnetization loss and thickness loss become large.

For the back coat layer 5, similarly to the lower non-magnetic layer 2 and the magnetic layer 3, it is possible to use not only the radiation curing polyurethane resin according to the present invention, but also thermoplastic resins, thermosetting or thermosensitive resins, radiation-sensitive modified resins, etc., as binders.

It is preferable that the back coat layer 5 contains 30 wt % to 80 wt %, inclusive, of carbon black. As the carbon black, there may be used any of conventionally used carbon blacks, and it is possible to use the same carbon black as used in the lower non-magnetic layer 2. Further, besides the carbon black, it is possible to use non-magnetic inorganic powders such as abrasives used for the magnetic layer 3, dispersants such as surfactants, higher fatty acids, fatty esters, lubricants such as silicone oil, and other various additives.

The thickness of the back coat layer 5 is 0.1 μm to 1.0 μm, preferably 0.2 μm to 0.8 μm, inclusive. When the thickness exceeds 1.0 μm, the friction between the back coat layer 5 and a passage with which the medium is in sliding contact becomes so large that the running stability of the magnetic tape 1 tends to become lower. On the other hand, if the thickness is lower than 0.1 μm, coating shaving tends to occur in the back coat layer 5 during the running of the magnetic tape 1.

The method of coating the base film 4 with the lower non-magnetic layer 2 and the magnetic layer 3 may be a wet-on-wet coating method in which coating of the magnetic layer 3 is provided while the lower non-magnetic layer 2 is wet, or a wet-on-dry coating method in which coating of the lower non-magnetic layer 2 is provided and after drying the same, coating of the magnetic layer 3 is provided. However, to highly control the surface properties of both the layers 2 and 3 with a view to improving the recording density, it is preferable that after the lower non-magnetic layer 2 is cured, the coating of magnetic layer 3 is provided according to the wet-on-dry coating method.

According to this magnetic tape 1, the above-described radiation curing polyurethane resin is used as the binder for the functional layers of the lower non-magnetic layer 2 and the magnetic layer 3, whereby it is possible to reliably cure the radiation curing polyurethane resin with a lower radiation dose. As a result, it is possible to reliably realize the lower non-magnetic layer 2 and the magnetic layer 3 having a sufficient coating film strength.

### EXAMPLES

Next, the magnetic tape 1 according to the present invention will be described based on Examples.

Example of Synthesis of Electron Beam-Curing Vinyl Chloride Resin (1)

A one-liter three-neck flask was charged with 424 parts by weight of isophorone diisocyanate, 0.4 parts by weight of dibutyltin dilaurate, and 0.24 parts by weight of 2,6-tert-butyl-4-methylphenol (BHT), and 372 parts by weight of 2-hydroxypropyl acrylate was added dropwise into the mixture while controlling the same to 60° C. After completion of the dropwise addition of the 2-hydroxypropyl acrylate, the resulting mixture was stirred for two hours at 60° C., and then taken out to obtain an IPDI-HPA adduct.

Then, 630 parts by weight of MR110 manufactured by Nippon Zeon Co., Ltd. was dissolved in 1470 parts by weight of MEK, and the water content of the obtained mixture was measured to find that the mixture had a water content of 0.03%. So, the water content of the mixture was adjusted to 0.2%. Then, 3.97 parts by weight of dibutyltin dilaurate and 0.35 parts by weight of N-nitrosophenyl hydroxylamine aluminum salt were added thereto, and the mixture was stirred at 70° C. for three hours, whereafter 547 parts by weight of the IPDI-HPA adduct obtained above was added thereto. After completion of the addition, the mixture was stirred at 70° C. for fifteen hours, and after confirming disappearance of characteristic absorption (2270 cm⁻¹) of the isocyanate group from IR spectrum, 0.35 parts by weight of N-nitrosophenyl hydroxylamine aluminum salt and 296 parts by weight of MEK were added, and the mixture was stirred for mixing and then taken out to obtain an electron beam-curing vinyl chloride resin (1).

Example of Synthesis of Electron Beam-Curing Polyurethane Resin (1)

A one-liter three-neck flask was charged with 508 parts by weight of an isocyanurate compound of isophorone diisocyanate, 0.48 parts by weight of dibutyltin dilaurate, 0.34 parts by weight of 2,6-tert-butyl-4-methylphenol (BHT), and 172 parts by weight of toluene, and while controlling the mixture to 60° C., 180 parts by weight of 2-hydroxyethyl methacrylate (2-HEMA) was added dropwise to the mixture. After completion of the dropwise addition, the mixture was stirred at 60° C. for two hours, and then taken out to obtain a resin A.

Next, 1670 parts by weight of a thermosetting polyurethane resin (aliphatic segment: 100 wt %; aromatic segment: 0 wt %; sulfur-containing polar group (—SO₃Na): 0.10 mmol/g) was charged, and the water content was measured to find that the resin had a water content of 0.03%. So, the water content of the resin was adjusted to 0.2%. Then, 3.3 parts by weight of dibutyltin acetylacetonate and 0.55 parts by weight of 2,6-tert-butyl-4-methylphenol (BHT) were charged, and 531 parts by weight of the resin A obtained above was added thereto. After completion of the addition, the mixture was stirred at 70° C. for fifteen hours, and after confirming disappearance of characteristic absorption (2270 cm⁻¹) of the isocyanate group from IR spectrum, 1403 parts by weight of MEK was added thereto, and the resulting mixture was stirred for mixing and then taken out to obtain an electron beam-curing polyurethane resin (1).

Example of Synthesis of Electron Beam-Curing Polyurethane Resin (2)

An electron beam-curing polyurethane resin (2) was obtained similarly to the synthesis of electron beam-curing polyurethane resin (1) except that a thermosetting polyurethane resin (aliphatic segment: 92 wt %; aromatic segment: 8 wt %; sulfur-containing polar group (—SO₃Na): 0.10 mmol/g) was used as the polyurethane resin.

Example of Synthesis of Electron Beam-Curing Polyurethane Resin (3)

An electron beam-curing polyurethane resin (3) was obtained similarly to the synthesis of electron beam-curing polyurethane resin (1) except that a thermosetting polyurethane resin (aliphatic segment: 74 wt %; aromatic segment: 26 wt %; sulfur-containing polar group (—SO₃Na): 0.10 mmol/g) was used as the polyurethane resin.

Example of Synthesis of Electron Beam-Curing Polyurethane Resin (4)

An electron beam-curing polyurethane resin (4) was obtained similarly to the synthesis of electron beam-curing polyurethane resin (1) except that a thermosetting polyurethane resin (aliphatic segment: 66 wt %; aromatic segment: 34 wt %; sulfur-containing polar group (—SO₃Na): 0.10 mmol/g) was used as the polyurethane resin.

Example of Synthesis of Electron Beam-Curing Polyurethane Resin (5)

An electron beam-curing polyurethane resin (5) was obtained similarly to the synthesis of electron beam-curing polyurethane resin (1) except that a thermosetting polyurethane resin (aliphatic segment: 50 wt %; aromatic segment: 50 wt %; sulfur-containing polar group (—SO₃Na): 0.10 mmol/g) was used as the polyurethane resin.

Example of Synthesis of Electron Beam-Curing Polyurethane Resin (6)

An electron beam-curing polyurethane resin (6) was obtained similarly to the synthesis of electron beam-curing polyurethane resin (1) except that a thermosetting polyurethane resin (aliphatic segment: 0 wt %; aromatic segment: 100 wt %; sulfur-containing polar group (—SO₃Na): 0.10 mmol/g) was used as the polyurethane resin.

Example of Synthesis of Electron Beam-Curing Polyurethane Resin (7)

A one-liter three-neck flask was charged with 508 parts by weight of isocyanurate compound of isophorone diisocyanate, 0.48 parts by weight of dibutyltin dilaurate, 0.34 parts by weight of 2,6-tert-butyl-4-methylphenol (BHT), and 172 parts by weight of toluene, and while controlling the mixture to 60° C., 180 parts by weight of 2-hydroxyethyl methacrylate was added dropwise to the mixture. After completion of the dropwise addition, the mixture was stirred at 60° C. for two hours, and then taken out to obtain a resin B.

Then, 1800 parts by weight of a thermosetting polyurethane resin (aliphatic segment: 100 wt %; aromatic segment: 0 wt %; sulfur-containing polar group (—SO₃Na): 0.10 mmol/g) was charged and the water content was measured to find that the resin had a water content of 0.03%. So, the water content of the resin was adjusted to 0.1%. Then, 3.1 parts by weight of dibutyltin acetylacetonate and 0.48 parts by weight of 2,6-tert-butyl-4-methylphenol (BHT) was charged, and 290 parts by weight of the resin B obtained above was added thereto. After completion of the addition, the mixture was stirred at 70° C. for fifteen hours, and then disappearance of characteristic absorption (2270 cm⁻¹) of the isocyanate group from IR spectrum was confirmed. Subsequently, 1092 parts by weight of MEK was added, and the mixture was stirred for mixing and then taken out to obtain an electron beam-curing polyurethane resin (7).

Example of Synthesis of Electron Beam-Curing Polyurethane Resin (8).

An electron beam-curing polyurethane resin (8) was obtained similarly to the synthesis of electron beam-curing polyurethane resin (7) except that a thermosetting polyurethane resin (aliphatic segment: 92 wt %; aromatic segment: 8 wt %; sulfur-containing polar group (—SO₃Na): 0.10 mmol/g) was used as the polyurethane resin.

Example of Synthesis of Electron Beam-Curing Polyurethane Resin (9)

An electron beam-curing polyurethane resin (9) was obtained similarly to the synthesis of electron beam-curing polyurethane resin (7) except that a thermosetting polyurethane resin (aliphatic segment: 74 wt %; aromatic segment: 26 wt %; sulfur-containing polar group (—SO₃Na): 0.10 mmol/g) was used as the polyurethane resin.

Example of Synthesis of Electron Beam-Curing Polyurethane Resin (10)

An electron beam-curing polyurethane resin (10) was obtained similarly to the synthesis of electron beam-curing polyurethane resin (7) except that a thermosetting polyurethane resin (aliphatic segment: 66 wt %; aromatic segment: 34 wt %; sulfur-containing polar group (—SO₃Na): 0.10 mmol/g) was used as the polyurethane resin.

Example of Synthesis of Electron Beam-Curing Polyurethane Resin (11)

An electron beam-curing polyurethane resin (11) was obtained similarly to the synthesis of electron beam-curing polyurethane resin (7) except that a thermosetting polyurethane resin (aliphatic segment: 50 wt %; aromatic segment: 50 wt %; sulfur-containing polar group (—SO₃Na): 0.10 mmol/g) was used as the polyurethane resin.

Example of Synthesis of Electron Beam-Curing Polyurethane Resin (12)

An electron beam-curing polyurethane resin (12) was obtained similarly to the synthesis of electron beam-curing polyurethane resin (7) except that a thermosetting polyurethane resin (aliphatic segment: 0 wt %; aromatic segment: 100 wt %; sulfur-containing polar group (—SO₃Na): 0.10 mmol/g) was used as the polyurethane resin.

Example of Synthesis of Electron Beam-Curing Polyurethane Resin (13)

A one-liter three-neck flask was charged with 508 parts by weight of an isocyanurate compound of isophorone diisocyanate, 0.47 parts by weight of dibutyltin dilaurate, 0.33 parts by weight of 2,6-tert-butyl-4-methylphenol (BHT), and 167 parts by weight of toluene, and while controlling the mixture to 60° C., 161 parts by weight of 2-hydrokyethyl acrylate (2-HEA) was added dropwise to the mixture. After completion of the dropwise addition, the mixture was stirred at 60° C. for two hours, and then taken out to obtain a resin C.

Then, 1600 parts by weight of a thermosetting polyurethane resin (aliphatic segment: 100 wt %; aromatic segment: 0 wt %; sulfur-containing polar group (—SO₃Na): 0.10 mmol/g) was charged and the water content was measured to find that the resin had a water content of 0.03%. So, the water content of the resin was adjusted to 0.2%. Then, 3.1 parts by weight of dibutyltin acetylacetonate, and 0.5 parts by weight of 2,6-tert-butyl-4-methylphenol (BHT) was charged, and 477 parts by weight of the resin C obtained above was added thereto. After completion of the addition, the mixture was stirred at 70° C. for fifteen hours, and then disappearance of characteristic absorption (2270 cm⁻¹) of the isocyanate group from IR spectrum was confirmed. Subsequently, 1348 parts by weight of MEK was added, and the mixture was stirred for mixing and then taken out to obtain an electron beam-curing polyurethane resin (13).

Example of Synthesis of Electron Beam-Curing Polyurethane Resin (14)

An electron beam-curing polyurethane resin (14) was obtained similarly to the synthesis of electron beam-curing polyurethane resin (13) except that a thermosetting polyurethane resin (aliphatic segment: 92 wt %; aromatic segment: 8 wt %; sulfur-containing polar group (—SO₃Na): 0.10 mmol/g) was used as the polyurethane resin.

Example of Synthesis of Electron Beam-Curing Polyurethane Resin (15)

An electron beam-curing polyurethane resin (15) was obtained similarly to the synthesis of electron beam-curing polyurethane resin (13) except that a thermosetting polyurethane resin (aliphatic segment: 74 wt %; aromatic segment: 26 wt %; sulfur-containing polar group (—SO₃Na): 0.10 mmol/g) was used as the polyurethane resin.

Example of Synthesis of Electron Beam-Curing Polyurethane Resin (16)

An electron beam-curing polyurethane resin (16) was obtained similarly to the synthesis of electron beam-curing polyurethane resin (13) except that a thermosetting polyurethane resin (aliphatic segment: 66 wt %; aromatic segment: 34 wt %; sulfur-containing polar group (—SO₃Na): 0.10 mmol/g) was used as the polyurethane resin.

Example of Synthesis of Electron Beam-Curing Polyurethane Resin (17)

An electron beam-curing polyurethane resin (17) was obtained similarly to the synthesis of electron beam-curing polyurethane resin (13) except that a thermosetting polyurethane resin (aliphatic segment: 50 wt %; aromatic segment: 50 wt %; sulfur-containing polar group (—SO₃Na): 0.10 mmol/g) was used as the polyurethane resin.

Example of Synthesis of Electron Beam-Curing Polyurethane Resin (18)

An electron beam-curing polyurethane resin (18) was obtained similarly to the synthesis of electron beam-curing polyurethane resin (13) except that a thermosetting polyurethane resin (aliphatic segment: 0 wt %; aromatic segment: 100 wt %; sulfur-containing polar group (—SO₃Na): 0.10 mmol/g) was used as the polyurethane resin.

Example of Synthesis of Electron Beam-Curing Polyurethane Resin (19)

An electron beam-curing polyurethane resin (19) was obtained similarly to the synthesis of electron beam-curing polyurethane resin (1) except that a thermosetting polyurethane resin (aliphatic segment: 100 wt %; aromatic segment: 0 wt %; sulfur-containing polar group (—SO₃Na): 0.01 mmol/g) was used as the polyurethane resin.

Example of Synthesis of Electron Beam-Curing Polyurethane Resin (20)

An electron beam-curing polyurethane resin (20) was obtained similarly to the synthesis of electron beam-curing polyurethane resin (1) except that a thermosetting polyurethane resin (aliphatic segment: 100 wt %; aromatic segment: 0 wt %; sulfur-containing polar group (—SO₃Na): 0.05 mmol/g) was used as the polyurethane resin.

Example of Synthesis of Electron Beam-Curing Polyurethane Resin (21)

An electron beam-curing polyurethane resin (21) was obtained similarly to the synthesis of electron beam-curing polyurethane resin (1) except that a thermosetting polyurethane resin (aliphatic segment: 100 wt %; aromatic segment: 0 wt %; sulfur-containing polar group (—SO₃Na): 0.10 mmol/g) was used as the polyurethane resin.

Example of Synthesis of Electron Beam-Curing Polyurethane Resin (22)

An electron beam-curing polyurethane resin (22) was obtained similarly to the synthesis of electron beam-curing polyurethane resin (1) except that a thermosetting polyurethane resin (aliphatic segment: 100 wt %; aromatic segment: 0 wt %; sulfur-containing polar group (—SO₃Na): 0.01 mmol/g; basic polar group (—N(C₂H₅)₂): 0.05 mmol/g) was used as the polyurethane resin.

Example of Synthesis of Electron Beam-Curing Polyurethane Resin (23)

An electron beam-curing polyurethane resin (23) was obtained similarly to the synthesis of electron beam-curing polyurethane resin (1) except that a thermosetting polyurethane resin (aliphatic segment: 100 wt %; aromatic segment: 0 wt %; sulfur-containing polar group (—SO₃Na): 0.05 mmol/g; basic polar group (—N(C₂H₅)₂): 0.05 mmol/g) was used as the polyurethane resin.

Example of Synthesis of Electron Beam-Curing Polyurethane Resin (24)

An electron beam-curing polyurethane resin (24) was obtained similarly to the synthesis of electron beam-curing polyurethane resin (1) except that a thermosetting polyurethane resin (aliphatic segment: 100 wt %; aromatic segment: 0 wt %; sulfur-containing polar group (—SO₃Na): and 0.10 mmol/g; basic polar group (—N(C₂H₅)₂): 0.05 mmol/g) was used as the polyurethane resin.

Although in the above Examples of synthesis of the electron beam-curing polyurethane resins (19) to (24), the water content of thermosetting polyurethane resin was adjusted to 0.2% by way of example, this is not limited, but by adjusting the same to an arbitrary value at least within a range of 0.1% to 0.2%, it is possible to synthesize the electron beam-curing polyurethane resins (19) to (24). Further, besides the electron beam-curing polyurethane resins (19) to (24), the synthesis of an electron beam-curing resin was tried similarly to the example of synthesis of electron beam-curing polyurethane resin (1), except that a thermosetting polyurethane resin (aliphatic segment: 100 wt %; aromatic segment: 0 wt %; sulfur-containing polar group (—SO₃Na): 0.15 mmol/g) was employed as the polyurethane resin. Also, the synthesis of an electron beam-curing resin was tried similarly to the example of synthesis of electron beam-curing polyurethane resin (1), except that a thermosetting polyurethane resin (aliphatic segment: 100 wt %; aromatic segment: 0 wt %; sulfur-containing polar group (—SO₃Na): 0.15 mmol/g; basic polar group (—N(C₂H₅)₂): 0.05 mmol/g) was employed as the polyurethane resin. However, these thermosetting polyurethane resins containing 0.15 mmol/g of sulfur-containing polar group (—SO₃Na) were so high in viscosity that it was difficult to adjust the water content, and hence the electron beam-curing polyurethane resin could not be prepared.

Evaluation 1: Crosslinking Property Evaluation

The electron beam-curing polyurethane resins (1) to (18) were adjusted to a solid concentration of 20 wt % (solvent: MEK), and used as a coating liquid. The coating liquid was applied on a release film by an applicator, and dried at 90° C. for five minutes to prepare a resin coating film having a thickness of 25 μm, which was used as a sample for measuring a gel fraction. An electron beam of 2.0 Mrad was irradiated to the obtained resin coating film which had not been electron beam-cured, to perform electron beam curing. Then, the resin coating film which has been cured (hereinafter referred to as “the cured resin coating film”) was peeled off from the release film, and cut into a size of approximately 1 cm×4 cm. The weight (denoted as A (g)) of the cut out cured resin coating film was measured, and then the cured resin coating film was refluxed within MEK for five hours. After the reflux, the cured resin coating film was dried at 60° C. for 24 hours, and the weight (denoted as B (g)) of the cured resin coating film was measured. Using the obtained results, the gel fraction of the electron beam-curing resin under the above-described irradiation dose condition is determined by the following equation:
Gel fraction(%)=(B/A)×100

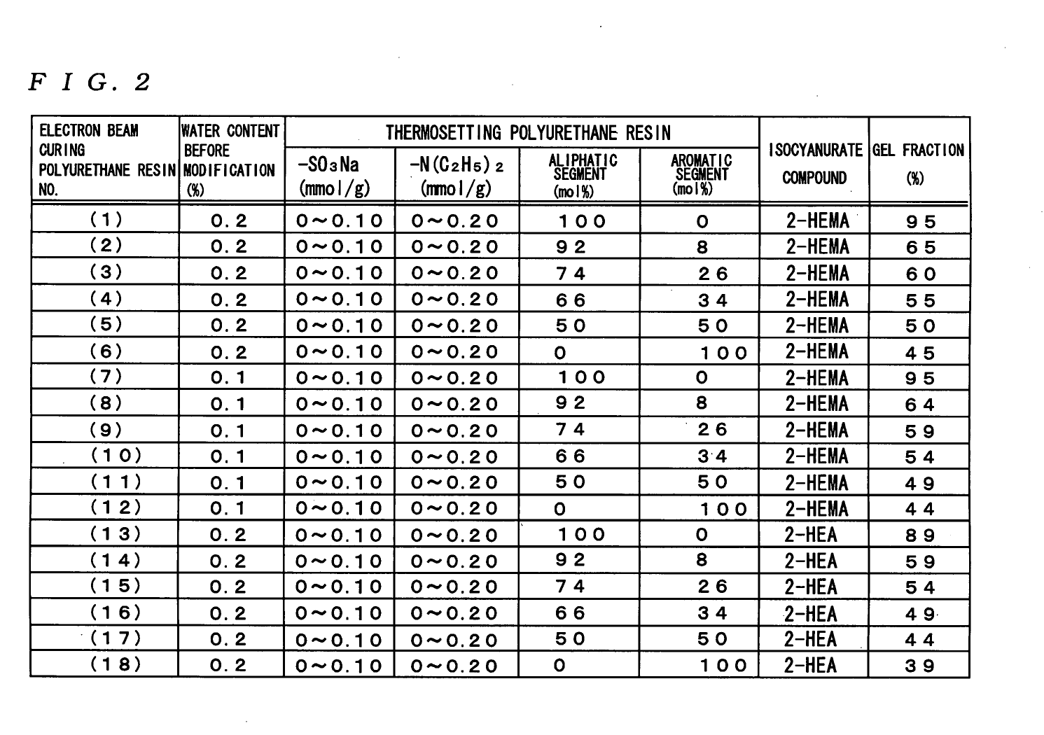

The results of measurement of the gel fraction are shown in FIG. 2. From the results of measurement, it was confirmed that the electron beam-curing polyurethane resins (1), (7), and (13) have more excellent crosslinking property even with a low electron beam dose such as 2.0 Mrad, compared with the other electron beam-curing polyurethane resins. Further, as the electron beam-curing polyurethane resins (1) to (18), the present inventors synthesized electron beam-curing polyurethane resins using a thermosetting polyurethane resin (aliphatic segment: 100 wt %; aromatic segment: 0 wt %) containing a sulfur-containing polar group (—SO₃Na) in an amount within a range of not lower than 0 mmol/g to not higher than 0.10 mmol/g and a basic polar group (—N(C₂H₅)₂) in an amount within a range of not lower than 0 mmol/g to not higher than 0.20 mmol/g, inclusive, in place of the thermosetting polyurethane resin containing only the sulfur-containing polar group (—SO₃Na), and the above-described crosslinking property evaluation was performed on these electron beam-curing polyurethane resins as well, and measurement results similar to those obtained from the electron beam-curing polyurethane resins (1) to (18) were obtained. From these measurement results, it was confirmed that the electron beam-curing resins obtained by modifying the thermosetting polyurethane resins which contain only an aliphatic segment but do not contain an aromatic segment have more excellent crosslinking property even with a low electron beam dose of e.g., 2.0 Mrad, compared with the electron beam-curing polyurethane resins obtained by modifying thermosetting polyurethane resins which have an aromatic segment, and provide cured films which have excellent solvent-resistant properties both against magnetic coating material and non-magnetic coating material.

Next, magnetic tapes were prepared using the electron beam-curing vinyl chloride resins and the electron beam-curing polyurethane resins described above, in the following manner.

### Example 1

(Preparation of the Non-Magnetic Coating Material)

Pigment: needle-shaped α-FeOOH 80.0 parts by weight
   (average major axis length: 0.1 μm; crystallite diameter: 12 nm),
Carbon black 20.0 parts by weight
   (manufactured by Mitsubishi Chemical Corporation; trade name: #950B; average particle diameter: 17 nm; BET specific surface area: 250 m²/g; DBP oil absorption: 70 ml/100 g; pH: 8),
Electron-beam curing vinyl chloride resin (1) 12.0 parts by weight
Electron-beam curing polyurethane resin (20) 10.0 parts by weight
Dispersant: phosphoric acid surfactant 3.2 part by weight
   (manufactured by TOHO Chemical Industry Co., LTD.; trade name: RE610), and
Abrasive: α-alumina 5.0 parts by weight
   (manufactured by Sumitomo Chemical Co., Ltd.; trade
name: HIT60A; average particle diameter: 0.18 μm)
NV (solid concentration)=33% (mass percentage) and
Solvent ratio: MEK/toluene/cyclohexanon=2/2/1 (mass ratio)

The above-mentioned materials were kneaded by a kneader, and then the kneaded mixture was dispersed by a horizontal pin mill filled with 0.8 mm zirconia beads at a filling ratio of 80% (void ratio of 50 vol %). Thereafter,
Lubricant: fatty acid 0.5 parts by weight
   (manufactured by NOF CORPORATION; trade name: NAA180),
Lubricant: fatty acid amide 0.5 parts by weight
   (manufactured by KAO CORPORATION; trade name: Fatty Acid Amide S), and
Lubricant agent: fatty ester 1.0 parts by weight
   (manufactured by Nikko Chemicals Co., Ltd.; trade name: NIKKOLBS)
   were further added and the mixture was diluted such that
NV (solid concentration)=25% (mass percentage), and
Solvent ratio: MEK/toluene/cyclohexanon=2/2/1 (mass percentage)
   hold, and was dispersed. The obtained coating material was filtered through a filter with an absolute filtration accuracy of 3.0 μm to thereby prepare a non-magnetic coating material.

(Preparation of the Magnetic Coating Material)
Magnetic powder: Fe-based needle-shaped ferromagnetic powder 100.0 parts by weight
(Fe/Co/Al/Y=100/24/5/8 (atomic ratio); Hc: 188 kA/m;
σs: 140 Am²/kg, BET specific surface area: 50 m²/g; average major axis length: 0.10 μm),
Binder resin: vinyl chloride copolymer 10.0 parts by weight
   (manufactured by Nippon Zeon Co., Ltd.; trade name: MR110),
Binder resin: polyester polyurethane 6.0 parts by weight
   (manufactured by Toyobo Co., Ltd.; trade name: UR8300),
Dispersant: phosphoric acid surfactant 3.0 parts by weight
   (manufactured by TOHO Chemical Industry Co., LTD.; trade name: RE610)
Abrasive: α-alumina 10.0 parts by weight
   (manufactured by Sumitomo Chemical Co., Ltd.; trade name: HIT60A; average particle diameter: 0.18 μm)
NV (solid concentration)=30% (mass percentage)
Solvent ratio: MEK/toluene/cyclohexanon=4/4/2 (mass a ratio).

The above-mentioned materials were kneaded by a kneader, and the kneaded material was pre-dispersed by a horizontal pin mill filled with 0.8 mm zirconia beads at a filling ratio of 80% (void ratio of 50 vol %). Thereafter, the pre-dispersed material was diluted such that
NV (solid concentration)=15% (mass percentage), and
Solvent ratio: MEK/toluene/cyclohexane=22.5/22.5/55 (mass ratio)
   hold, and then finishing dispersion was carried out. 3 parts by weight of a curing agent (Colonate L manufactured by NIPPON POLYURETHANE INDUSTRY Co., LTD.) was added to the obtained coating material and mixed therewith, whereafter the coating material was further filtered through a filter with an absolute filtration accuracy of 1.5 μm to thereby prepare the magnetic coating material.

(Preparation of the Back Coat Layer Coating Material)
Carbon black 75 parts by weight
   (manufactured by Cabot Corporation; trade name: BP-800 (average particle diameter: 17 nm; DBP oil absorption 68 ml/100 g; BET specific surface area: 210 m²/g)),
Carbon black 15 parts by weight
   (manufactured by Cabot Corporation, trade name: BP-130 (average particle diameter: 75 nm; DBP oil absorption: 69 ml/100 g, BET specific surface area: 25 m²/g)),
Calcium carbonate 10 parts by weight
   (manufactured by SHIRAISHI KOGYO KAISHA, LTD.; trade name: Hakuenka O; average particle diameter: 30 nm),
Nitrocellulose 65 parts by weight
   (manufactured by Asahi Kasei Corporation; trade name: BTH1/2),
Polyurethane resin 35 parts by weight
   (aliphatic polyester diol/aromatic polyester diol=43/57),
NV (solid concentration)=30% (mass percentage)
Solvent ratio: MEK/toluene/cyclohexanon=1/1/1 (mass ratio)

In a state in which part of organic solvents is removed, the mixture of the above-mentioned materials was fully kneaded using a kneader in a highly viscous state. Then, after adding an appropriate amount of organic solvents to the mixture and the mixture was fully stirred using a dissolver, pre-dispersing processing was carried out at a dispersing peripheral speed of 7 m/s and a retention time of 60 minutes in a dispersing machine filled with zirconia beads having an average particle diameter of 0.8 mm to a filling volume percentage of 80%, while performing circulating supply.

The obtained mixed solution was diluted by further adding solvents thereto, such that:

NV (solid content)=10% (mass percentage), and

Solvent ratio: MEK/toluene/cyclohexane=5/4/1 (mass ratio)

hold, and in a dispersing machine filled with zirconia beads having an average particle diameter of 0.8 mm to a filling volume percentage of 80%, finishing dispersing processing was carried out at a dispersing peripheral speed of 7 m/s and a retention time of 10 minutes, while performing circulating supply.

10 parts by weight of a curing agent (Colonate L manufactured by NIPPON POLYURETHANE INDUSTRY Co., LTD.) was added to the thus prepared back coat coating material and mixed therewith, and the obtained coating material was fully stirred using a dissolver, and then filtered through a filter with an absolute filtration accuracy of 1.5 μm to thereby prepare the desired back coat layer coating material.

(Step of Forming the Lower Non-Magnetic Layer)

The above-described non-magnetic coating material was applied onto one surface of the base film 4 (polyethylene naphthalate film) with a thickness of 6.2 μm from a nozzle by an extrusion coating method so that the applied coating material has a thickness of 2.0 μm after calendering, and then dried. Thereafter, the calendering processing was carried out using a calender in which a plastic roll and a metal roll are combined, passing through the nip four times, at a processing temperature of 100° C., under a linear pressure of 3500 N/cm, and at a speed of 160 m/minute, and then electron beam irradiation was carried out with a dose of 4.2 Mrad at an acceleration voltage of 200 kV to form the lower non-magnetic layer 2.

(Step of Forming the Magnetic Layer)

The above-described magnetic coating material was applied onto the lower non-magnetic layer 2 formed as above, using a nozzle so that the applied coating material has a thickness of 0.2 μm after calendering, then orientated and dried. Thereafter, the calendering processing was carried out using a calender in which a plastic roll and a metal roll are combined, passing through the nip four times, at a processing temperature of 100° C., under a linear pressure of 3500 N/cm, and at a speed of 160 m/minute to form the magnetic layer 3.

(Step of Forming the Back Coat Layer)

The above-described back coat layer coating material was applied onto the other surface of the base film 4 formed as described above, using a nozzle so that the applied coating material has a dry thickness of 0.7 μm, and then dried. Thereafter, the calendering processing was carried out using a calender in which a plastic roll and a metal roll are combined, passing through the nip four times, at a processing temperature of 100° C., under a linear pressure of 3500 N/cm, and at a speed of 100 m/sec to form the back coat layer 5.

The raw magnetic recording tape thus obtained was thermally cured at 60° C. for 48 hours, and slit (cut) to a width of ½ inch (=12.650 mm). Thus, a data tape as a magnetic recoding tape sample was formed as Example 1.

### Example 2

A magnetic tape sample as Example 2 was made similarly to Example 1, except that the electron beam-curing polyurethane resin (20) was replaced by the electron beam-curing polyurethane resin (21).

### Examples 3 to 6

A magnetic tape sample as Example 3 was made similarly to Example 1, except that the electron beam-curing polyurethane resin (20) was replaced by the electron beam-curing polyurethane resin (1). Also, a magnetic tape sample as Example 4 was made similarly to Example 1, except that the electron beam-curing polyurethane resin (20) was replaced by the electron beam-curing polyurethane resin (7). Also, a magnetic tape sample as Example 5 was made similarly to Example 3, except that the condition for irradiating an electron beam in the step of forming the lower non-magnetic layer was set at 2.0 Mrad instead of 4.2 Mrad. Also, a magnetic tape sample as Example 6 was made similarly to Example 4, except that the condition for irradiating an electron beam in the step of forming the lower non-magnetic layer was set at 2.0 Mrad instead of 4.2 Mrad.

### Comparative Examples 1 to 6

Magnetic tape samples as Comparative Examples 1 to 4 were made similarly to Example 1, except that the electron beam-curing polyurethane resin (20) was replaced by the electron beam-curing polyurethane resins (19), (22) to (24), respectively. Also, a magnetic tape sample as Comparative Example 5 was made similarly to Example 1, except that the electron beam-curing polyurethane resin (20) was replaced by the electron beam-curing polyurethane resin (13). Also, a magnetic tape sample as Comparative Example 6 was made similarly to Comparative Example 5, except that the condition for irradiating an electron beam in the step of forming the lower non-magnetic layer was set at 2.0 Mrad instead of 4.2 Mrad.

[Evaluation of Magnetic Tapes]

The following evaluation was performed on the magnetic tape samples.

Evaluation 2: Center Line Surface Roughness (Ra)

Using “TALYSTEP system” (manufactured by Taylor Hobson Ltd), and based on JIS B0601-1982, center line surface roughness Ra on the surface of the magnetic layer 3 was measured on the samples of Examples 1 and 2 and Comparative Examples 1 to 6. The conditions of measurement were set to a filter of 0.18 Hz to 9 Hz, a stylus of 0.1 μm×2.5 μm, a stylus pressure of 2 mg, a measuring speed of 0.03 mm/sec and a measurement length of 500 μm. It should be noted that measurement of the surface roughness (Ra) on the surface of the magnetic layer 3 was carried out after the final calendering processing and curing processing.

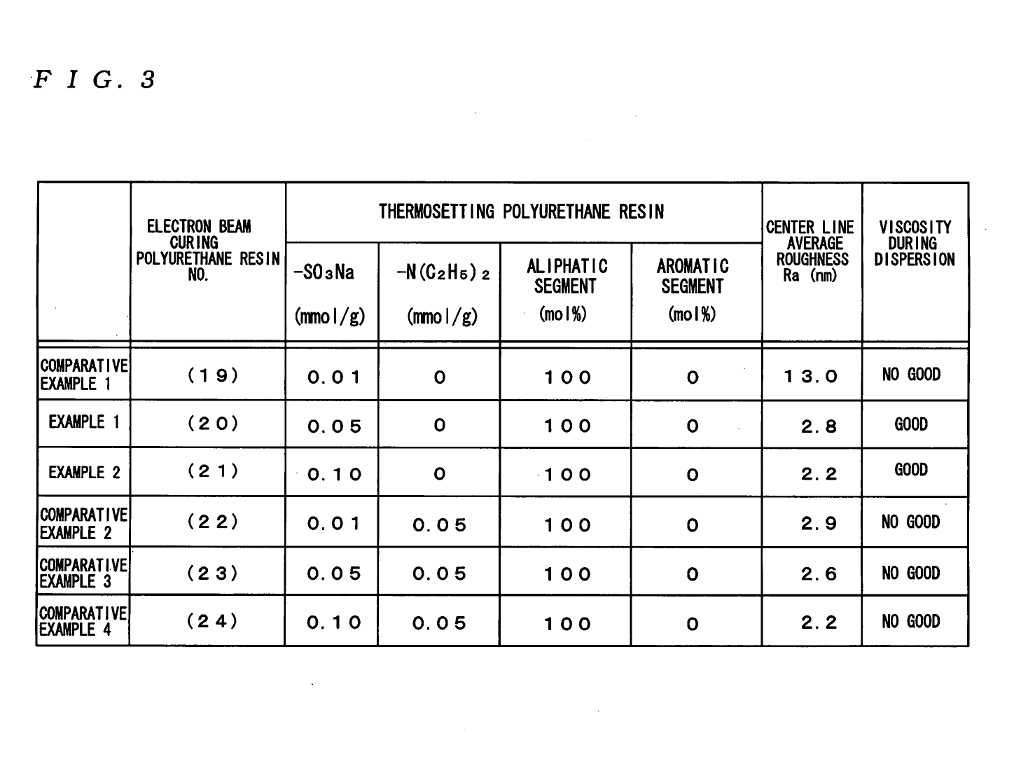

Results of measurement of the center line surface roughness (Ra) are shown in FIG. 3. From the measurement results, it was confirmed that in the samples of Examples 1 and 2 in which there are used the electron beam-curing polyurethane resins (20) and (21) that are obtained by modifying the thermosetting polyurethane resins which contain only sulfur-containing polar groups (—SO₃Na) in an amount of not less than 0.05 mmol/g to not more than 0.10 mmol/g, inclusive, in their molecule and are formed only by an aliphatic segment, it is possible to reduce the center line surface roughness (Ra) to a sufficiently low value, and hence it is possible to form the magnetic layer 3 so that it has a sufficiently smooth surface. It was also confirmed that in the samples of Comparative Examples 2, 3 and 4 in which there are used the electron beam-curing polyurethane resins (22), (23) and (24) that are obtained by modifying the thermosetting polyurethane resins which contain sulfur-containing polar groups (—SO₃Na) in an amount of not less than 0.01 mmol/g to not more than 0.10 mmol/g, inclusive, and a basic polar group (—N(C₂H₅)₂) in an amount of 0.05 mmol/g in their molecule and are formed only by an aliphatic segment, it is possible to reduce the center line surface roughness (Ra) to a sufficiently low value, and hence it is possible to form the magnetic layer 3 so that it has a sufficiently smooth surface. Further, during the preparation of the samples of Examples and Comparative Examples, a check was also made as to the viscosity of the non-magnetic coating material, which is used in the lower non-magnetic layer 2 during dispersion thereof. According to the check of the viscosity, it was confirmed that while the viscosity of the non-magnetic coating material for Examples 1 and 2 during dispersion thereof is appropriate, the viscosity of those for Comparative Examples 2, 3, and 4 during dispersion thereof is very high. Similarly, it was also confirmed that during preparation of the non-magnetic coating material for the lower non-magnetic layer 2, which is used in the preparation of the sample of Comparative Example 1, the viscosity of the non-magnetic coating material during dispersion thereof is very high. Therefore, it was confirmed that the electron beam-curing polyurethane resins (19), (22), (23), and (24) are not suitable for the material of the non-magnetic coating material for the lower non-magnetic layer 2.

Evaluation 3: Tape Hardness

Using an ultra-micro indentation hardness tester (trade name: ENT-1100 manufactured by ELIONIX Co., Ltd.), a loading-unloading test was carried out on the samples of Examples 3 to 6 and Comparative Examples 5 and 6 to measure the tape hardness. Conditions of the measurement were as follows: testing load: 10 mgf; number of measurement points: 6; number of divisions: 100; step interval: 100 msec.

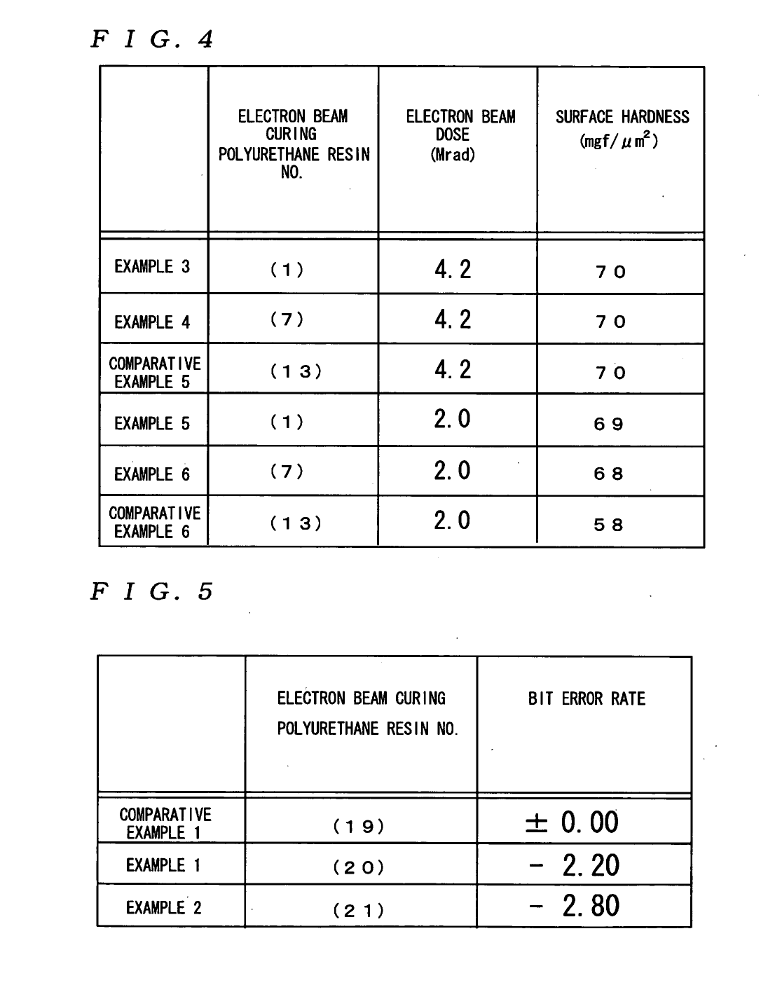

Results of measurement of the tape hardness are shown in FIG. 4. From the results, it was confirmed that the samples of Examples 3 and 4 using the electron beam-curing polyurethane resins (1) and (7) and Comparative Example 5 using the electron beam-curing resin (13) have sufficient tape hardness. On the other hand, it was confirmed that in spite of the electron beam dose for the samples of Examples 5 and 6 being as low as 2.0 Mrad, these samples have sufficient tape hardness similarly to Examples 3 and 4 and Comparative Example 5 described above. In contrast, it was confirmed that the sample of Comparative Example 6 using the electron beam-curing polyurethane resin (13) does no have sufficient tape hardness when the electron beam dose is made equal to that for Examples 5 and 6. Therefore, it was confirmed that by using the electron beam-curing polyurethane resins (1) and (7) using 2-hydroxyehtyl methacrylate as the modifying compound, unlike the case of using the electron beam-curing polyurethane resin (13) using 2-hydroxyethyl acrylate as the modifying compound, a magnetic tape having sufficient tape hardness can be made even with a low electron beam dose of 2.0 Mrad, similarly to the case in which the electron beam dose is 4.2 Mrad.

Evaluation 4: Bit Error Rate

A magnetic recording head and a reproducing head are mounted on a SFTES (Small Format Tape Evaluation System) manufactured by MAC Co., Ltd., a single recording wavelength signal having a recording wavelength of 0.25 μm is recorded by the magnetic recording head on each sample of Examples 1 and 2 and Comparative Example 1 integrated into respective cartridges, whereby a signal having a P-P value (amplitude) of not more than 50% with respect to a P-P value (amplitude) of a signal recorded in advance by a tape length of 2.54 cm is set as a missing pulse, and four or more consecutive missing pulses are detected as a long defect. The number of long defects per one meter of Comparative Example 1 as the reference tape is set to N and the number of long defects detected per one meter of each of Examples 1 and 2 is set to X, whereby Log₁₀(X/N) is calculated as a bit error rate as to Comparative Example 1 and Examples 1 and 2, for comparison therebetween. It should be noted that a magnetoresistive effect-type magnetic head (MR head) was used as the reproducing head.

Results of comparison of bit error rates as described above are shown in FIG. 5. From the results, it was confirmed that samples of Examples 1 and 2 using the electron beam-curing polyurethane resins (20) and (21) can attain a sufficiently low bit error rate compared with Comparative Example 1 which is worst in the center line average roughness Ra.

As described above, from the results of Evaluations 1 to 4, it is understood that by using electron beam-curing polyurethane resins obtained by modifying thermosetting polyurethane resins which contain only a sulfur-containing polar group (—SO₃Na) in an amount of not less than 0.05 mmol/g to not more than 0.10 mmol/g, inclusive, in their molecule and are formed only by an aliphatic segment in an electron beam sensitive manner, it is possible, even with a low electron beam dose of 2.0 Mrad, to manufacture magnetic tapes 1 which have sufficiently high surface hardness (coating film strength), with a sufficiently low center line average roughness Ra, and yet are sufficiently low in bit error rate. Further, since the magnetic tapes 1 can be manufactured with a low electron beam dose, it is possible to sufficiently enhance productivity. Further, according to the magnetic tape 1, it is possible to realize a magnetic recording medium which is sufficiently high in the strength (coating film strength) of the lower non-magnetic layer 2 and the magnetic layer 3 by curing the electron beam-curing polyurethane resins with a low radiation dose. Further, since the electron beam curing polyurethane resins can be cured with a low radiation dose, the productivity can be sufficiently enhanced, therefore it is possible to realize inexpensive magnetic tapes 1.

What is claimed is:

1. A radiation curing polyurethane resin for a magnetic recording medium, produced by modyfing a polyurethane resin which contains active hydrogen, and a sulfur-containing polar group in an amount of not less than 0.05 mmol/g to not more than 0.10 mmol/g, inclusive, but does not contain a basic polar group in its molecule and is formed only by an aliphatic segment, the polyurethane resin being modified on the active hydrogen into a radiation curing type by a compound having an acrylic double bond.

2. A method of manufacturing the radiation curing polyurethane resin for a magnetic recording medium, wherein a polyurethane resin which contains active hydrogen, and a sulfur-containing polar group in an amount of not less than 0.05 mmol/g to not more than 0.10 mmol/g, inclusive, but does not contain a basic polar group in its molecule and is formed only by an aliphatic segment is used as a raw material, and the active hydrogen is caused to react with a compound having an acrylic double bond in its molecule, whereby the polyurethane resin is modified into a radiation curing type, when manufacturing a radiation curing polyurethane resin for a magnetic recording medium recited in claim 1.

3. A method of manufacturing a radiation curing polyurethane resin for a magnetic recording medium according to claim 2, wherein as the compound, there is used a compound obtained by causing an isocyanate to react with an alcohol which contains at least one acrylic double bond in its molecule.

4. A magnetic recording medium comprising a lower non-magnetic layer and a magnetic layer formed in the mentioned order on one surface of a non-magnetic substrate, wherein the lower non-magnetic layer contains the radiation curing polyurethane resin recited in claim 1 for a magnetic recording medium.
